(19) United States
(12) Patent Application Publication
(10) Pub. No.: US 2019/0165966 A1
(43) Pub. Date: May 30, 2019

(54) METHOD AND SYSTEM FOR QUALITY CONTROL OF A FACILITY BASED ON MACHINE LEARNING

(71) Applicant: Ruptub Solutions Private Limited, Karnataka (IN)

(72) Inventors: Sidharth Gupta, Bangalore (IN); Kadam Jeet Jain, Bangalore (IN); Rahul Chaudhary, Bangalore (IN); Punit Garg, Bangalore (IN); Khilan Haria, Bangalore (IN); Ankita Gandhi, Agra (IN); Vidit Sinha, Bangalore (IN); Rajdeep Singh, Karnataka (IN); Abhishek Nair, Mumbai (IN); Shashank Rao, Bangalore (IN); Shubhangi Agarwal, Lucknow (IN); Abhishek Malani, Hyderabad (IN); Raghavendra Reddy, Andhra Pradesh (IN); Ribin Paikattu Kavil, Bangalore (IN); Rahul Boggaram Nagarjuna Gupta, Bangalore (IN)

(21) Appl. No.: 15/897,656

(22) Filed: Feb. 15, 2018

(30) Foreign Application Priority Data
Nov. 25, 2017 (IN) 201741042322

(51) Int. Cl. H04L 12/28; G06F 15/18; G06K 9/00; G06Q 50/12

(52) U.S. Cl. CPC H04L 12/2825; G06Q 50/12; G06K 9/00671; G06F 15/18

(57) ABSTRACT

A method and system for quality control of a digital facility based on machine learning. The system connects a plurality of elements associated with a plurality of regions of the digital facility. The system allocates a unique identity to the plurality of elements. The system receives a set of data associated with the plurality of regions. The system collects a set of data associated with a plurality of micro descriptors. The system processes the second set of data to discover a plurality of patterns. The system predicts issues associated with the plurality of elements. The system assigns high severity issue to the one or more severe issues. The system stores information associated with the digital facility. The system updates the patterns associated with the plurality of elements. The system recommends characteristic parameters to the plurality of elements. The system notifies manpower associated with the digital facility.

### CROSS-REFERENCES TO RELATED APPLICATION

The present application claims the benefit under 35 U.S.C. § 119(e) of the filing date of India Patent Application Serial No. 201741042322 for SYSTEM FOR QUALITY CONTROL OF A FACILITY BASED ON MACHINE LEARNING, filed Nov. 25, 2017 which is hereby incorporated by reference in its entirety for all purposes.

### TECHNICAL FIELD

The present disclosure relates to a field of quality control and management. More specifically, the present disclosure relates to a method for quality control of a facility based on machine learning.

### BACKGROUND

Service industry has taken a major leap with the huge increase in number of people constantly travelling from one place to another. People are in constant need for a place to stay overnight or for a few days. Typically, people stay in various hotels which match their needs and comfort ability factor. These hotels have been operating in an automated fashion since very long. Nowadays, there are innumerable software systems for managing hotel operations in real time. Further, these hotels continuously try to evolve and understand their customer needs in order to be more efficient. Maintenance of quality of the hotels is a big task for hotel owners. In addition, managing the quality of the facility needs time and money. Managing quality of the facility includes a regular audit of the facility, solving multiple major issues related to the facility and monitoring a large number of tasks related to the audit. Maintaining the quality of a facility requires one or more devices in order to collect information and perform certain number of tasks. The devices use wired connection in order to keep them connected to the main server and perform its task. Using the wired connection has a downside as a single loose wire will affect the performance of the system and the devices does not provide information in real time to keep track on the quality of the facility. As an example, the feedback provided by the customer is used to make changes which are applied after the visitor has left the facility which decrease the quality of service of the facility. Therefore, the wired connections do not provide efficient way of communicating information from devices and are not reliable. Further, information collected is stored separately for each device and does not prove to be useful for keeping track on the overall quality of the facility. In order to check all the aspects of the quality by using all the devices working together with each other, there is a need for a new system which overcomes the above-stated disadvantages.

### SUMMARY

In a first example, a computer-implemented method is provided. The computer-implemented method may be configured to perform quality control of a digital facility based on machine learning. The computer-implemented method may include a first step of connecting a plurality of elements associated with a plurality of regions of the digital facility. The computer-implemented method may include a second step of allocating a unique identity to each of the plurality of element. The unique identity is allocated based on a pre-defined pattern. The computer-implemented method may include a third step of receiving a first set of data associated with each of the plurality of regions of the digital facility. The first set of data comprises of a plurality of architectural data. The computer-implemented method may include a fourth step of collecting a second set of data associated with a plurality of micro descriptors. Each of the plurality of micro descriptors is associated with one or more of the plurality of elements. The computer-implemented method may include a fifth step of processing the second set of data to discover a plurality of patterns. The processing is done based on attribute of the second set of data. Each of the plurality of patterns is associated with a characteristic attribute of one or more of the plurality of elements. The computer-implemented method may include a sixth step of predicting one or more issues associated with one or more of the plurality of elements. The prediction is enabled with the facilitation of machine learning. The prediction is done in real time. The computer-implemented method may include a seventh step of assigning one or more high severity issue to the one or more severity issues. The one or more high severity issue is assigned based on second set of data and machine learning. The computer-implemented method may include an eighth step of storing a plurality of sets of information associated with the digital facility. The plurality of sets of information is stored in a plurality of matrices. The plurality of sets of information is stored in a database of quality control system. The computer-implemented method may include a ninth step of updating the plurality of patterns associated with the plurality of elements of the digital facility. The plurality of patterns is updated in the database of quality control system. The computer-implemented method may include a tenth step of recommending a plurality of optimum characteristic parameters to each of the plurality of elements. The plurality of optimum characteristic parameters is recommended to ensure quality of each of the plurality of elements. The computer-implemented method may include an eleventh step of notifying one or more manpower associated with the digital facility.

In an embodiment of the present disclosure, the plurality of architectural sources include a facility manager, a digital camera, a digital blueprint, a communication device, one or more graphical sensors and a satellite image.

In an embodiment of the present disclosure, the plurality of elements includes a plurality of electrical appliances, a plurality of furniture, a plurality of sanitary fittings, a plurality of structural fittings, a plurality of cutleries and a plurality of washroom fittings.

In an embodiment of the present disclosure, the one or more issue comprises fault in one or more of the plurality of electrical appliance, fault in one or more of the plurality of furniture, fault in one or more of the plurality of sanitary fittings, fault in one or more of the plurality of structural fittings, fault in one or more of the plurality of cutleries and fault in one or more of the plurality of washroom fittings.

In an embodiment of the present disclosure, the computer-implemented method further includes yet another step of upgrading the first set of data, the second set of data, the one or more issues and the one or more high severity issue. The upgrading is done in real time.

In an embodiment of the present disclosure, the computer-implemented method further includes yet another step of preventing booking of one or more of the plurality of regions of the digital facility. The prevention is done with the facilitation of the one or more high severity issue and machine learning. The prevention is done in real time.

In an embodiment of the present disclosure, the computer-implemented method further includes yet another step of forecasting a time to resolve the one or more issues in order to maintain quality of the digital facility. The forecasting is done based on machine learning.

In an embodiment of the present disclosure, the unique identity differentiates each of the plurality of elements of the digital facility. The plurality of micro descriptors is coupled with the unique identity.

In an embodiment of the present disclosure, the plurality of micro descriptors provides data of a plurality of characteristic attributes of plurality of elements.

In a second example, a computer system is provided. The computer system may include one or more processors and a memory coupled to the one or more processors. The memory may store instructions which, when executed by the one or more processors, may cause the one or more processors to perform a method. The method is configured to perform quality control of a digital facility based on machine learning. The method may include a first step of connecting a plurality of elements associated with a plurality of regions of the digital facility. The method may include a second step of allocating a unique identity to each of the plurality of element. The unique identity is allocated based on a pre-defined pattern. The method may include a third step of receiving a first set of data associated with each of the plurality of regions of the digital facility. The first set of data comprises of a plurality of architectural data. The method may include a fourth step of collecting a second set of data associated with a plurality of micro descriptors. Each of the plurality of micro descriptors is associated with one or more of the plurality of elements. The method may include a fifth step of processing the second set of data to discover a plurality of patterns. The processing is done based on attribute of the second set of data. Each of the plurality of patterns is associated with a characteristic attribute of one or more of the plurality of elements. The method may include a sixth step of predicting one or more issues associated with one or more of the plurality of elements. The prediction is enabled with the facilitation of machine learning. The prediction is done in real time. The method may include a seventh step of assigning one or more high severity issue to the one or more severity issues. The one or more high severity issue is assigned based on second set of data and machine learning. The method may include an eighth step of storing a plurality of sets of information associated with the digital facility. The plurality of sets of information is stored in a plurality of matrices. The plurality of sets of information is stored in a database of quality control system. The method may include a ninth step of updating the plurality of patterns associated with the plurality of elements of the digital facility. The plurality of patterns is updated in the database of quality control system. The method may include a tenth step of recommending a plurality of optimum characteristic parameters to each of the plurality of elements. The plurality of optimum characteristic parameters is recommended to ensure quality of each of the plurality of elements. The method may include an eleventh step of notifying one or more manpower associated with the digital facility.

In a third example, a computer-readable storage medium is provided. The computer-readable storage medium encodes computer executable instructions that, when executed by at least one processor, performs a method. The method is configured to perform quality control of a digital facility based on machine learning. The method may include a first step of connecting a plurality of elements associated with a plurality of regions of the digital facility. The method may include a second step of allocating a unique identity to each of the plurality of element. The unique identity is allocated based on a pre-defined pattern. The method may include a third step of receiving a first set of data associated with each of the plurality of regions of the digital facility. The first set of data comprises of a plurality of architectural data. The method may include a fourth step of collecting a second set of data associated with a plurality of micro descriptors. Each of the plurality of micro descriptors is associated with one or more of the plurality of elements. The method may include a fifth step of processing the second set of data to discover a plurality of patterns. The processing is done based on attribute of the second set of data. Each of the plurality of patterns is associated with a characteristic attribute of one or more of the plurality of elements. The method may include a sixth step of predicting one or more issues associated with one or more of the plurality of elements. The prediction is enabled with the facilitation of machine learning. The prediction is done in real time. The method may include a seventh step of assigning one or more high severity issue to the one or more severity issues. The one or more high severity issue is assigned based on second set of data and machine learning. The method may include an eighth step of storing a plurality of sets of information associated with the digital facility. The plurality of sets of information is stored in a plurality of matrices. The plurality of sets of information is stored in a database of quality control system. The method may include a ninth step of updating the plurality of patterns associated with the plurality of elements of the digital facility. The plurality of patterns is updated in the database of quality control system. The method may include a tenth step of recommending a plurality of optimum characteristic parameters to each of the plurality of elements. The plurality of optimum characteristic parameters is recommended to ensure quality of each of the plurality of elements. The method may include an eleventh step of notifying one or more manpower associated with the digital facility.

### BRIEF DESCRIPTION OF FIGURES

Having thus described aspects of the enclosed embodiments in general terms, reference will now be made to the accompanying drawings, which are not necessarily drawn to scale, and wherein:

FIG. 1A illustrates a block diagram of a digital facility, in accordance with an embodiment of the present disclosure;

FIG. 1B illustrates an interactive computing environment for quality control of the digital facility based on machine learning, in accordance with various embodiments of the present disclosure;

FIG. 2A and FIG. 2B illustrate a flowchart for a method for quality control of the digital facility based on the machine learning, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

Reference will now be made in detail to selected embodiments of the present disclosure in conjunction with accompanying figures. The embodiments described herein are not intended to limit the scope of the present disclosure, and the present disclosure should not be construed as limited to the embodiments described. This present disclosure may be embodied in different forms without departing from the scope and spirit of the disclosed embodiments. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

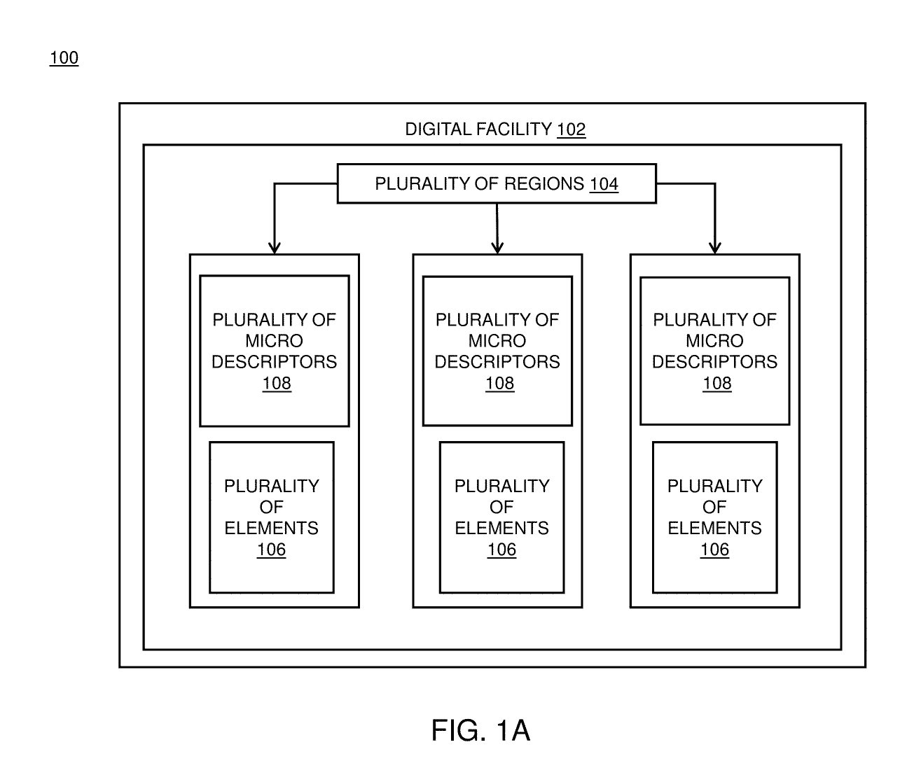

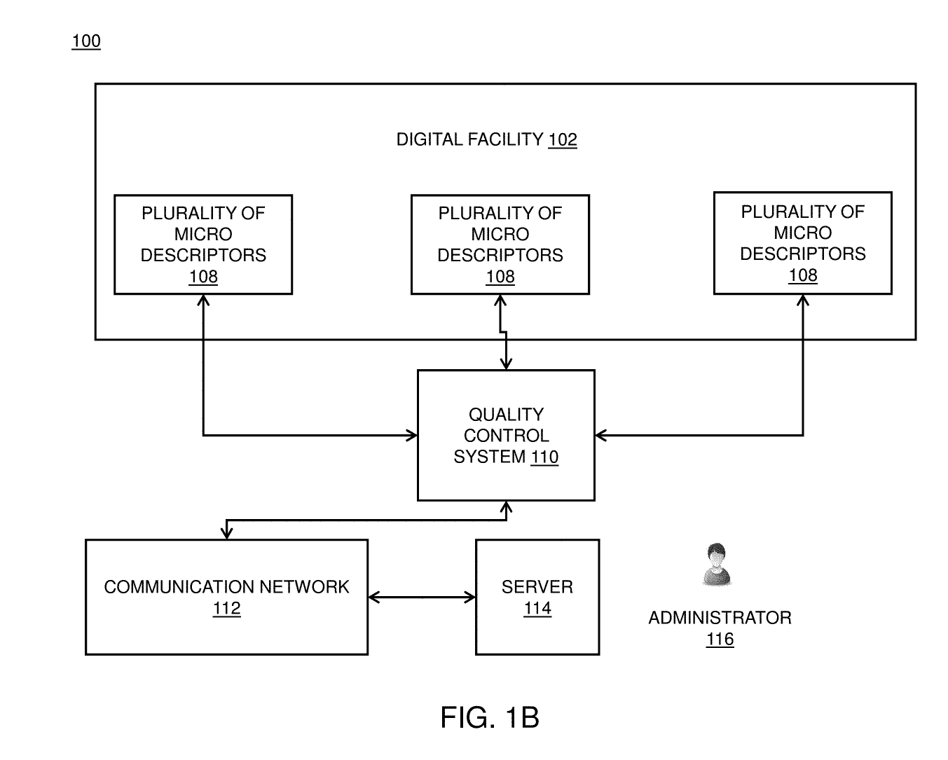

FIG. 1A illustrates a block diagram 100 of a digital facility 102, in accordance with an embodiment of the present disclosure. FIG. 1B illustrates another block diagram 100 of the digital facility 102 for quality control of the digital facility 102 based on machine learning, in accordance with various embodiments of the present disclosure. The digital facility 102 is an accommodation for human beings or pets to live or stay for a period of time. The digital facility 102 is a hotel providing accommodation, meals, and hospitality services for guest and visitors on a short-term or long-term basis. In an embodiment of the present disclosure, the digital facility 102 is a space for conducting seminars, conferences, meetings, social gatherings, family functions, events, and the like. In another embodiment of the present disclosure, the digital facility 102 is a hospital providing health care services to human beings or animals. In yet another embodiment of the present disclosure, the digital facility 102 is a temporary or permanent residence of one or more human beings. In yet another embodiment of the present disclosure, the digital facility is an educational institution. In yet another embodiment of the present disclosure, the digital facility 102 may be a guest house providing accommodation facility to guests or visitors. In yet another embodiment of the present disclosure, the digital facility 102 is a military base operated by or for the military. In yet another embodiment of the present disclosure, the digital facility 102 is an old age home or any other social institution of the like. In yet another embodiment of the present disclosure, the digital facility 102 is an office or a financial institution of the like. In yet another embodiment of the present disclosure, the digital facility 102 is a lodge, boarding house or a supermarket. In yet another embodiment of the present disclosure, the digital facility 102 includes but may not be limited to production area of a factory or an industry. In yet another embodiment of the present disclosure, the digital facility 102 includes but may not be limited to supermarket, cinema hall, railway station, bus station and the like. In yet another embodiment of the present disclosure, the digital facility 102 is government undertaking.

The digital facility 102 includes a plurality of regions 104. The plurality of regions 104 facilitates differentiation and specification of various area sections of the digital facility 102. The plurality of regions 104 is differentiated to facilitate systematic identification of the plurality of regions 104 for a quality control system 110. The plurality of regions 104 includes but may not be limited to a plurality of rooms, one or more common area, one or more restaurants, one or more parking, one or more kitchens, one or more gardens, one or more reception areas, one or more corridors and one or more stairs. In an embodiment of the present disclosure, the plurality of regions 104 includes any other regions. In another embodiment of the present disclosure, the plurality of regions 104 includes but may not be limited to shopping areas, cash counters, baggage counters, ticket counters, help desks, waiting areas, washrooms, sanitary areas, conference areas, and the like. In yet another embodiment of the present disclosure, the plurality of regions 104 includes but may not be limited to the meeting areas, event spaces, ground areas, fitness areas, gyms, swimming areas, classroom areas, dining areas and the like. In an embodiment of the present disclosure, the plurality of regions 104 may vary.

Each of the plurality of regions 104 includes a plurality of elements 106. The plurality of elements 106 is various components that enable structure, security, functionality and comfort of the plurality of regions 104. In an embodiment of the present disclosure, the plurality of elements 106 may be of any other suitable form of the like. The plurality of elements 106 includes but may not be limited to structural elements, functional elements, sanitary elements, security elements, entertainment elements, decorative elements and electrical elements. In an embodiment of the present disclosure, the plurality of elements 106 includes any other suitable elements of the like. The quality control system 110 connects the plurality of elements 106 associated with the plurality of regions 104 of the digital facility 102.

The plurality of elements 106 in each of the plurality of regions 104 vary with the functionality or purpose of each of the plurality of regions 104. For example, consider a region of the plurality of regions 104 to be a room. The structural elements of the room are walls of the room, floor of the room, ceiling of the room, windows of the room and doors of the room. In an embodiment of the present disclosure, the structural elements of the room include any other suitable elements of the like. The functional elements of the room are one or more bed, one or more chairs, one or more tables and one or more closets. In another embodiment of the present disclosure, the functional elements of the room include any other suitable elements of the like. The sanitary elements of the room are cleanliness, hygiene, one or more table cloths, one or more curtains, one or more linen and one or more pillows. In yet another embodiment of the present disclosure, the sanitary elements of the room include any other suitable elements of the like. The security elements of the room are one or more locks, one or more security camera, one or more security alarm, one or more fire extinguisher and a smart security system. In yet another embodiment of the present disclosure, the security elements of the room include any other suitable elements of the like. The entertainment elements of the room are one or more music systems, one or more musical instruments, one or more gaming systems, one or more communication devices, one or more computer devices, one or more smartphone devices and one or more printed reading materials. In yet another embodiment of the present disclosure, the entertainment elements of the room include any other suitable elements of the like. The decorative elements of the room are one or more flower bouquet, one or more painting, one or more indoor plant, one or more display piece and one or more work of art. In yet another embodiment of the present disclosure, the decorative elements of the room include any other suitable elements of the like. The electrical elements of the room are one or more lighting device, one or more refrigerators, one or more air conditioners, one or more fans, one or more water heaters, one or more switches, one or more electrical sockets and one or more televisions. In yet another embodiment of the present disclosure, the electrical elements of the room include any other suitable elements of the like.

The quality control system 110 allocates a unique identity to each of the plurality of elements 106. In general, a unique identity facilitates in differentiation and identification of each of the plurality of elements 106. The unique identity is allocated to each of the plurality of elements 106 based on a pre-defined pattern. The pre-defined pattern allocates similar identity to the plurality of elements 106 of a region of the plurality of regions 104. The pre-defined pattern allocates similar identity to similar characteristic elements of the plurality of elements 106. In an embodiment of the present disclosure, the pre-defined pattern allocates the unique identity with any other suitable manner of the like. The unique identity facilitates in integrations of a plurality of data associated with the plurality of elements 106. The unique identity enables systematic processing of the plurality of data associated with each of the plurality of elements 106. The unique identity facilitates in real time access to a particular data of the plurality of data associated with each of the plurality of elements 106. In an embodiment of the present disclosure, the unique identity is allocated on the basis of any other suitable distribution pattern of the like.

The quality control system 110 receives a first set of data associated with each of the plurality of regions 104 of the digital facility 102. The first set of data includes a plurality of architectural data. The first set of data is received is from a plurality of architectural data sources. The plurality of architectural data includes but may not be limited to geographical data, images, videos, 3-D outlines, a master plan, laser scanned images, 360° camera images, blueprints of facility, engineering drawings and the like. In an embodiment of the present disclosure, the plurality of architectural data includes any other suitable data. The first set of data includes detailed architectural data of each of the plurality of regions 104 of the digital facility 102. The first set of data includes detailed architectural data of the plurality of elements 106 of each of the plurality of regions 104 of the digital facility 102. The quality control system 110 processes the first set of data to generate detailed visual representation of the digital facility 102 on a digital platform. In an embodiment of the present disclosure, the quality control system 110 processes the first set of data for any suitable purpose. In another embodiment of the present disclosure, the quality control system 110 stores the first set of data.

The first set of data includes but may not be limited to the architectural data associated with digital facility 102. The first set of data includes detailed information of arrangement and physical characteristics the plurality of elements 106 of each of the plurality of regions 104. The first set of data includes interior data of the plurality of regions 104, multimedia data of the plurality of regions 104, 3-D view of the plurality of regions 104 and the like. In an embodiment of the present disclosure, the first set of data includes any other suitable data of the like. In an embodiment of the present disclosure, the architectural information includes but is not be limited to building architecture, ambience architecture of the digital facility 102, satellite view of the digital facility 102, and the like. In another embodiment of the present disclosure, architectural data includes any other suitable architectural data of the like.

The quality control system 110 processes the first set of data to generate a digital replica of the digital facility 102. The digital replica is identical virtual representation of the digital facility 102 on digital platform. The digital replica is identical virtual representation of each of the plurality of regions 104 of the digital facility 102. The digital replica is identical visual representation of each of the plurality of elements 106 of each of the plurality of regions 104 of the digital facility 102. The digital replica is an identical visual multimedia representation of the digital facility 102. The digital replica is an identical visual multimedia representation of each of the plurality of regions 104 of the digital facility 102. The digital replica is identical visual multimedia representation of the plurality of elements 106 of each of the plurality of regions 104 of the digital facility 102. The digital replica is a digital 3-D model of the digital facility 102. In an embodiment of the present disclosure, the digital replica is of any other suitable form of the like.

In addition, the quality control system 110 splits the digital replicas into one or more digital replicas. The one or more digital replicas correspond to a digital replica for each region of the plurality of regions 104 of the digital facility 102. The quality control enables the one or more digital with the facilitation of the first set of data. The quality control system 110 enables one or more digital replicas of each of the plurality of regions 104 for detailed information of the plurality of elements 106. The one or more digital replicas are identical virtual representation of each of the plurality of regions 104 of the digital facility 102. The one or more digital replicas represent in complete detail the plurality of elements 106 of each of the plurality of regions 104. The one or more digital replicas identically represent shape, size, location orientation and the like of the plurality of elements 106 of each of the plurality of regions 104. In an embodiment of the present disclosure, the one or more digital replicas collectively enable the digital replica of the digital facility 102. In another embodiment of the present disclosure, the one or more digital replicas represent any other suitable component of the digital facility 102.

The quality control system 110 associates and represents the unique identity of each of the plurality of elements 106 in the digital replica. The digital replica of the digital facility 102 visually represents the unique identity of each of the plurality of elements 106. The unique identity facilitates in differentiation and identification of each of the plurality of elements 106. The unique identity is allocated to each of the plurality of elements 106 based on a pre-defined pattern. The association of unique identity of each of the plurality of elements 106 with the corresponding digital replica facilitates in quality control and management of the digital facility 102. The unique identity of each of the plurality of elements 106 integrates data collection and data processing of data for the purpose of quality control and management. The unique identity of each of the plurality of elements 106 facilitates in preferential and subjective optimizations.

The quality control system 110 includes a plurality of micro descriptors 108. The plurality of micro descriptors 108 provides data of a plurality of characteristic attributes of each of the plurality of elements 106 of the digital facility 102. The plurality of micro descriptors 108 receive and provide data of a plurality of characteristic attributes of each of the plurality of elements 106 of the digital facility 102. The plurality of micro descriptors 108 are designed to retrieve accurate data of the plurality of characteristic attributes of the plurality of elements 106. The plurality of micro descriptors 108 are designed to provide accurate data of the plurality of characteristic attributes of the plurality of elements 106. In general, micro descriptors provide data of elementary attributes, characteristic features, hygiene condition, physical states, current condition and the like of elements associated with micro descriptors. In an embodiment of the present disclosure, the plurality of micro descriptors 108 provides any other suitable data. Each of the plurality of micro descriptors 108 is associated with one or more of the plurality of elements 106. Each of the plurality of elements 106 is associated with one or more of the plurality of micro descriptors 108. Each of the plurality of micro descriptors 108 is associated with similar one or more elements of the plurality of elements 106.

For example, a plurality of air conditioners in a region is associated with a first micro descriptor. In another example, a plurality of water valves in a region is associated with a second micro descriptor. The quality control system 110 employs the plurality of micro descriptors 108 to retrieve data of each of the plurality of elements 106. The plurality of micro descriptors 108 provide data of elementary attributes, characteristic features, physical state, operational parameters, current condition and the like of the plurality of elements 106. In an embodiment of the present disclosure, the plurality of micro descriptors 108 provides data of any other suitable parameters of the plurality of elements 106.

The plurality of micro descriptors 108 provides data of elementary attributes of each of the plurality of elements 106. The elementary attributes includes but may not be limited to shape, size, color, cleanliness, texture and motion. In an embodiment of the present disclosure, the plurality of micro descriptors 108 provides data of any other suitable elementary attributes of the like. The plurality of micro descriptors 108 provides data of characteristic features, physical state, operational parameter and current condition. The plurality of micro descriptors 108 are couples with the unique identity of each of the plurality of elements 106. Each of the plurality of micro descriptors 108 provides data of one or more of the plurality of elements 106 coupled with the unique identity. The quality control system 110 processes and stores data of each of the plurality of elements 106 coupled with unique identity. The unique identity of each of the plurality of elements 106 facilitates the quality control system 110 in differentiation and identification. The quality control system 110 processes and stores the data provided by the plurality of micro descriptors 108. The quality control system 110 controls and monitors each of the plurality of micro descriptors 108. The quality control system 110 governs and coordinates the operational performance of the plurality of micro descriptors 108. The quality control system 110 monitors the operations of the plurality of micro descriptors 108 in real time. The quality control system 110 manipulates different configurations of each of the plurality of micro descriptors 108 to receive desired characteristic data of the plurality of elements 106. In an embodiment of the present disclosure, the quality control system 110 controls any other suitable parameter of the plurality

In an embodiment of the present disclosure, each of the plurality of micro descriptors 108 is associated with a plurality of sensors and an embedded electronic system. The plurality of sensors sense and provide data of one or more of the plurality of characteristic attributes of each of the plurality of elements 106. The embedded electronic system is suitably designed to receive significant data of the plurality of attribute of the plurality of elements 106 with the facilitation of the plurality of sensors. Each of the plurality of micro descriptors 108 is associated with similar one or more elements of the plurality of elements 106. The embedded system and the plurality of sensors are configured to receive data of similar one or more elements of the plurality of elements 106. For example, a plurality of light bulbs in a region is associated with a micro descriptor with electrical sensors and a suitable embedded system. In another embodiment of the present disclosure, one or more of the plurality of micro descriptors 108 are associated with smart sensors with embedded computers systems. In yet another embodiment of the present disclosure, the plurality of micro descriptors 108 provides attribute data of the plurality of elements 106 with the facilitation of human feedback. In yet another embodiment of the present disclosure, the plurality of micro descriptors 108 directly receives human feedback about the plurality of elements 106 of the digital facility 102. In yet another embodiment of the present disclosure, the plurality of micro descriptors 108 receives human feedback about the plurality of elements 106 of the digital facility 102 with the facilitation of plurality of communication devices. In yet another embodiment of the present disclosure, the plurality of micro descriptors 108 receives human feedback about the plurality of elements 106 of the digital facility 102 with the facilitation of any other suitable device of the like. In yet another embodiment of the present disclosure, the plurality of micro descriptors 108 are digital descriptors specially designed for each of the plurality of elements 106. In yet another embodiment of the present disclosure, the plurality of micro descriptors are associated with sensors, embedded systems, computer system, connected devices, human feedback and the like. In yet another embodiment of the present disclosure, the plurality of micro descriptors 108 provides attribute data of the plurality of elements 106 with any other suitable mechanism of the like. In yet another embodiment of the present disclosure, the plurality of micro descriptors 108 is communication devices. The human feedback is received from a plurality of individuals associated with the digital facility 102. The human feedback may be received with the facilitation of plurality of communication devices.

The quality control system 110 collects a second set of data. The quality control system 110 collects the second set of data from the plurality of micro descriptors 108. The quality control system 110 collects the second set of data to ensure quality control of the digital facility 102. The quality control system 110 processes the second set of data. The quality control system 110 process the second set of data with the facilitation of machine learning. The processing of second set of data enables efficient and effective quality control and management of the digital facility 102. The processing of second set of data includes differentiating the plurality of characteristic attributes of each of the plurality of elements 106. The differentiation of the plurality of characteristic attributes facilitates in qualitative and quantitative analysis of the plurality of characteristic attributes. The differentiation of the plurality of characteristic attributes facilitates in monitoring of each of the plurality of attribute of the plurality of elements 106. The differentiation of the plurality of attribute facilitates in comparison of one or more of the plurality of attribute of similar one or more elements of the plurality of elements 106. In an embodiment of the present disclosure, the differentiation of the plurality of characteristic attributes facilitates in any other suitable processing of the like.

The second set of data includes a plurality of sets audit data. The quality control system 110 performs an audit process. The audit process is done at regular intervals on the digital facility 102. The audit process is done for each of the plurality of regions 104 of the digital facility 102. The audit process facilitates in maintaining quality of the digital facility 102. The audit process is done with the facilitation of one or more quality assurance manager. In an embodiment of the present disclosure, the audit process is done with the facilitation of one or more visitor of the digital facility. In another embodiment of the present disclosure, audit process is done with the facilitation of any other suitable mechanism of the like. The audits process provides the plurality of sets of audit data to associate with one or more of the plurality of elements 106 of the digital facility 102. The plurality of sets of audit data is a constituent element of the second set of data. In an embodiment of the present disclosure the plurality of sets of audit data is provided directly to the quality control system. In another embodiment of the present disclosure, the plurality of sets of data is associated with the quality control system 110 with the facilitation of any other suitable mechanism of the like.

In an embodiment of the present disclosure, the second set of data includes demographical data associated with the digital facility 102. In another embodiment of the present disclosure, the second set of data includes weather data associated with the digital facility 102. In yet another embodiment of the present disclosure, the second set of data includes occupancy data associated with the digital facility 102. In yet another embodiment of the present disclosure, the second set of data includes demand data of the digital facility 102 for different quarter or seasons of year. In yet another embodiment of the present disclosure, the second set of data includes data received from external data sources. In yet another embodiment of the present disclosure the second set of data includes any other suitable data of the like.

The processing of second set of data includes analysis of the plurality of characteristic attributes of the plurality of elements 106. The processing of the second set of data includes monitoring of the plurality of characteristic attributes of each of the plurality of elements 106. The processing of the second set of data includes comparison of one or more of the plurality of attribute of the plurality of elements 106. The processing of the second set of data includes storing of the plurality of characteristic attributes of each of the plurality of elements 106. The processing of the second set of data includes updating of the plurality of characteristic attributes of each of the plurality of elements 106. In an embodiment of the present disclosure, the processing of the second set of data includes any other suitable processing of the plurality of characteristic attributes of the each of the plurality of elements 106.

The quality control system 110 processes the second set of data to discover a plurality of patterns. Each of the plurality of patterns is associated with a characteristic attribute of the plurality of characteristic attributes of one or more of the plurality of elements 106. The quality control system 110 discovers the plurality of patterns with the facilitation of machine learning. In general, a pattern is a regular and intelligible form or sequence discernible in a way of occurring of an event. The quality control system 110 process the second set of data to discover the plurality of patterns in data of each of the plurality of characteristic attributes. For example, the quality control system 110 processes data associated with an air conditioner to discover a pattern in occurrence of a defect in functionality of compressor under various operating conditions. The plurality of patterns is observed in data of each of the plurality of characteristic attribute of the plurality of elements 106. The quality control system 110 employs machine learning to discover the plurality of patterns in data of each of the plurality of characteristic attribute of the plurality of elements 106.

The quality control system 110 predicts one or more issues associated with one or more of the plurality of elements 106 of the digital facility 102. The quality control system 110 predicts one or more issues with the facilitation of machine learning. The quality control system 110 predicts the one or more issues with the facilitation of the second set of data. The one or more issues corresponds to deviation of one or more of the plurality of characteristic attribute of one or more elements of the plurality of elements 106 from ideal attributes or ideal parameters. The quality control system 110 establishes the standard data in form of the ideal attributes or ideal parameters with the facilitation of machine learning. The ideal attribute and ideal parameter refer to attributes or parameters of the plurality of elements that enable highest possible working efficiency of the plurality of elements. The plurality of patterns facilitates the quality control system 110 in predicting the one or more issues associated with one or more of the plurality of elements 106 of the digital facility 102. The quality control system 110 predicts the one or more issues in real time.

The quality control system 110 predicts one or more issues associated with the digital facility 102 with the facilitation a plurality of predictive model. In general, predictive model refers to a variety of statistical techniques to analyze current and historical data to make predictions about future events or otherwise unknown events. The quality control system 110 executes the plurality of predictive model with the facilitation of machine learning. Each of the plurality of predictive model facilitates in accurately predicting the one or more issues associated with one or more of the plurality of elements 106. Each of the plurality of model is improved and trained with the facilitation of machine learning. Each of the plurality of predictive model is designed for one or more of the plurality of characteristic attribute. Each predictive model is suitable for one or more of the plurality of characteristic attribute of similar category. The plurality of characteristic attributes is different and unrelated. The quality control system 110 enables accurate predictions with the facilitation of different predictive models for different characteristic attributes. For example, one or more issues might be associated with staff or manpower associated with a digital facility, one or more issues might be seasonal and one or more issues might be associated with weather condition around a facility. In general, factors influencing different prediction are different as a result different predictive model has different inputs in the form of plurality of characteristic attributes.

The quality control system 110 employ different predictive models for predicting the one or more issues associated with similar elements of the plurality of elements 106. The quality control system 110 executes the plurality of predictive models with the facilitation of machine learning. In an embodiment of the present disclosure, the quality control system 110 executes the plurality of patterns with the facilitation of any other suitable mechanism. The quality control system 110 employs a plurality of predictive models. The plurality of predictive models employed by the quality control system 110 includes but may not be limited to tree based ensemble models. In an embodiment of the present disclosure, the plurality of predictive models includes random forests method. In another embodiment of the present disclosure, the plurality of predictive models includes extreme gradient boosted trees method. In yet another embodiment of the present disclosure, the quality control system 110 employ combination of two or more predictive methods for making predictions. In yet another embodiment of the present disclosure, the plurality of predictive models includes any other suitable predictive model of the like.

The one or more issues include fault, problem or inefficiency of one or more of the plurality of electrical appliance. The one or more issues include fault or problem in one or more of the plurality of furniture. The one or more issues include fault or problem in one or more of the plurality of sanitary fittings. The one or more issues include fault or problem in one or more of the plurality of structural fittings. The one or more issues includes problem in manpower associated with the digital facility 102. The one or more issues include fault or problem in one or more of the plurality of cutleries. The one or more issues include fault or problem in one or more of the plurality of washroom fittings. In an embodiment of the present disclosure, the one or more issues include any other fault or problem of the like. The fault corresponds to structural fault, mechanical fault, electrical fault, positioning fault, design fault and the like. The problem includes bad hygienic condition, inadequate cleanliness, uncomfortable, unpleasant, unhealthy, and unprofessional. In an embodiment of the present disclosure, the problem includes any other situation of the like.

In addition, the quality control system 110 compares the second set of data with the standard data. The quality control system 110 compares the second set of data in real time. The quality control system 110 evaluates a deviation of the second set of data with the standards data in order to predict one or more issue associated with one or more of the plurality of elements 106 the digital facility 102. The quality control system 110 evaluates the second set of data in real time. The quality control system 110 evaluates the deviation between the second set of data and the standard data. The deviation facilitates the quality control system 110 to predict one or more issue associated with one or more of the plurality of elements 106 in the digital facility 102. The deviation facilitates in assigning a degree of severity to the one or more issue.

The quality control system 110 assigns one or more high severity issue to the one or more issues. The one or more high severity issues correspond to the one or more issues with serious consequence on the performance of one or more of the plurality of elements 106. The quality control system 110 assigns the one or more high severity issues to the one or more issues based on machine learning. The quality control system 110 assigns the one or more high severity issues to the one or more issues based on the second set of data. For example, the quality control system 110 predicted a fault in air conditioner, based on second set of data the fault in air conditioner becomes a reason for a negative feedback, based on this the fault in air conditioner becomes a high severity issue. The quality control system 110 assigns the one or more high severity issues based on the human feedback of the one or more issues. In an embodiment of the present disclosure, the quality control system 110 assigns one or more high severity issues based on time to resolve the one or more issues in the past. For example, one or more complex issues of the one or more issues may be high severity due to excess amount of time involved in resolving the one or more complex issues.

In addition, the quality control system 110 stores a plurality of sets of information associated with the digital facility 102. The plurality of sets of information includes the first set of data, the second set of data, the plurality of patterns, one or more issues, the one or more high severity issues and the like. In an embodiment of the present disclosure, the plurality of sets of information includes any other suitable information of the like. The plurality of sets of information is stored in a plurality of matrices. The plurality of matrices stores the plurality of sets of information in a systematic and ordered pattern. The plurality of sets of information is stored in a database of quality control system 110. The database of the quality control system 110 stores the plurality of sets of information for processing with the facilitation of machine learning. The quality control system 110 stores the plurality of sets of information in real time.

The quality control system 110 updates the plurality of patterns associated with the plurality of elements 106 of the digital facility 102. The plurality of patterns is updated in the database of the quality control system 110. The plurality of patterns is updated based on the stored plurality of sets of information and machine learning. The plurality of patterns is updated in real time. In an embodiment of the present disclosure, the plurality of patterns is updated with the facilitation of any other suitable mechanism of the like. The quality control system 110 continuously processes the plurality of sets of information to update the plurality of patterns. Further, the quality control system 110 recommends a plurality of optimum characteristic parameters to each of the plurality of elements 106. The plurality of optimum characteristic parameters is recommended to ensure quality of each of the plurality of elements 106.

In addition, the quality control system 110 notifies the one or more manpower associated with the digital facility 102. The quality control system 110 notifies the manpower of the one or more issues and the one or more high severity issues. The one or more manpower refers to maintenance staff of the digital facility 102. In an embodiment of the present disclosure, the one or more manpower refers to managers of the digital facility 102. In another embodiment of the present disclosure, the one or more manpower refers to inspection staff of the digital facility 102. In yet another embodiment of the present disclosure, the one or more manpower refers to owner of the digital facility 102. In another embodiment of the present disclosure, the one or more manpower refers to any other suitable individual associated with the digital facility 102.

In addition, the quality control system 110 alerts the one or more manpower associated with the digital facility. The quality control system 110 alerts the one or more manpower to resolve the predicted one or more issue and the one or more high severity issues. The alerts are raised to resolve the issues to maintain the quality of the digital facility 102. The quality control system 110 alters the one or more manpower in real time. The one or more manpower includes but may not be limited to the maintenance staff, quality manager, the secret auditor, and the like. The quality control system 110 alerts by sending notification to one or more portable communication device of the one or more manpower of the digital facility 102. In an embodiment of the present disclosure, the quality control system 110 alerts the one or more manpower by any other suitable notification mechanism of the like.

In addition, the quality control system 110 prevents the booking of a particular region of the plurality of regions 104 of the digital facility 102. The quality control system 110 analyzes the one or more high severity issues associated with each region of the plurality of regions 104. The analysis is done in order to identify if the number of one or more high severity issues being higher or lower than a pre-defined standard limit. The pre-defined standard limit is established with the facilitation of machine learning. In case, the degree of severity is higher than the pre-defined standard limit the identified region of the plurality of regions 104 is prevented from booking. The quality control system 110 prevents the booking of the identified region of the plurality of regions 104 in real time. The quality control system 110 prevents booking of the identified region of the plurality of regions 104 until the degree of severity is reduced to meet the quality standard of the digital facility 102. In an embodiment of the present disclosure, the quality control system 110 prevents booking of the particular region of the plurality of regions 104 with the facilitation of any other suitable criteria of the like. In another embodiment of the present disclosure, the quality control system 110 prevents booking of the particular region of the plurality of regions 104 with the facilitation of any other suitable mechanism of the like.

The quality control system 110 forecasts a time to resolve the one or more issue in order to maintain quality of the digital facility 102. The quality control system 110 forecasts the time to resolve the one or more issue with the facilitation of the second set of data. The quality control system 110 forecasts the time to resolve the one or more issue with the facilitation of machine learning. The forecasting is done by analyzing the previously stored data and the data received in real time to forecast the time to resolve the one or more issues. The time to resolve the one or more issues facilitates in assigning the one or more high severity issues. In case, an issue is not resolved in the forecasted time, the quality control system 110 assigns a high severity status to the unresolved issue. In an embodiment of the present disclosure, the time to resolve the one or more issues facilitates in any other suitable processing of the like.

The quality control system 110 upgrades the first set of data to accurately predict and forecast. The quality control system 110 upgrades the first set of data in real time. The quality control system 110 upgrades the second set of data to accurately predict and forecast. The quality control system upgrades the second set of data in real time. The quality control system 110 upgrades the one or more issues to ensure quality management of the digital facility 102. The quality control system 110 upgrades the one or more high severity issue to ensure quality control of the digital facility 102. The quality control system 110 upgrades the second set of data in real time. In an embodiment of the present disclosure, the quality control system 110 upgrades any other suitable data of the like.

The quality control system 110 is connected with the server 114 with the facilitation of the communication network 112. In an embodiment of the present disclosure, the communication network 112 enables the quality control system 110 to gain access to the internet for transmitting data to the server 114. Moreover, the communication network 112 provides a medium to transfer the data between the quality control system 110 and the server 114. The server 114 handles each operation and task performed by the quality control system 110. The server 114 stores one or more instructions for performing the various operations of the quality control system 110.

In an embodiment of the present disclosure, the type of communication network 112 is a wireless mobile network. In another embodiment of the present disclosure, the type of communication network 112 is a wired network with a finite bandwidth. In yet another embodiment of the present disclosure, the type of communication network 112 is a combination of the wireless and the wired network for the optimum throughput of data transmission. In yet another embodiment of the present disclosure, the type of communication network 112 network is an optical fiber high bandwidth network that enables a high data rate with negligible connection drops. The communication network 112 includes a set of channels. Each channel of the set of channels supports a finite bandwidth. Moreover, the finite bandwidth of each channel of the set of channels is based on capacity of the communication network 112.

The quality control system 110 is connected to the server 114. In general, the server 114 is a computer program or device that provides functionality for other programs or devices. The server 114 provides various functionalities, such as sharing data or resources among multiple clients, or performing computation for a client. However, those skilled in the art would appreciate that more number of quality control system 110 are connected to more number of servers 114. Furthermore, it may be noted that the server 114 includes a database. However, those skilled in the art would appreciate that more number of the server 114 includes more numbers of databases.

In an embodiment of the present disclosure, the quality control system 110 is located in the server 114. In another embodiment of the present disclosure, the quality control system 110 is associated with the server 114. In yet another embodiment of the resent disclosure, the quality control system 110 is a part of the server 114. The server 114 handles each operation and task performed by the quality control system 110. The server 114 stores one or more instructions for performing the various operations of the quality control system 110. The server 114 is located remotely located from the one or more device.

The server 114 is associated with an administrator 116. In general, the administrator 116 manages the different components in the quality control system 110. The administrator 116 coordinates the activities of the components involved in the quality control system 110. The administrator 116 is any person or individual who monitors the working of the quality control system 110 and the server 114 in real time. The administrator 116 monitors the working of the quality control system 110 and the server 114 through a communication device. The communication device includes the laptop, the desktop computer, the tablet, a personal digital assistant and the like.

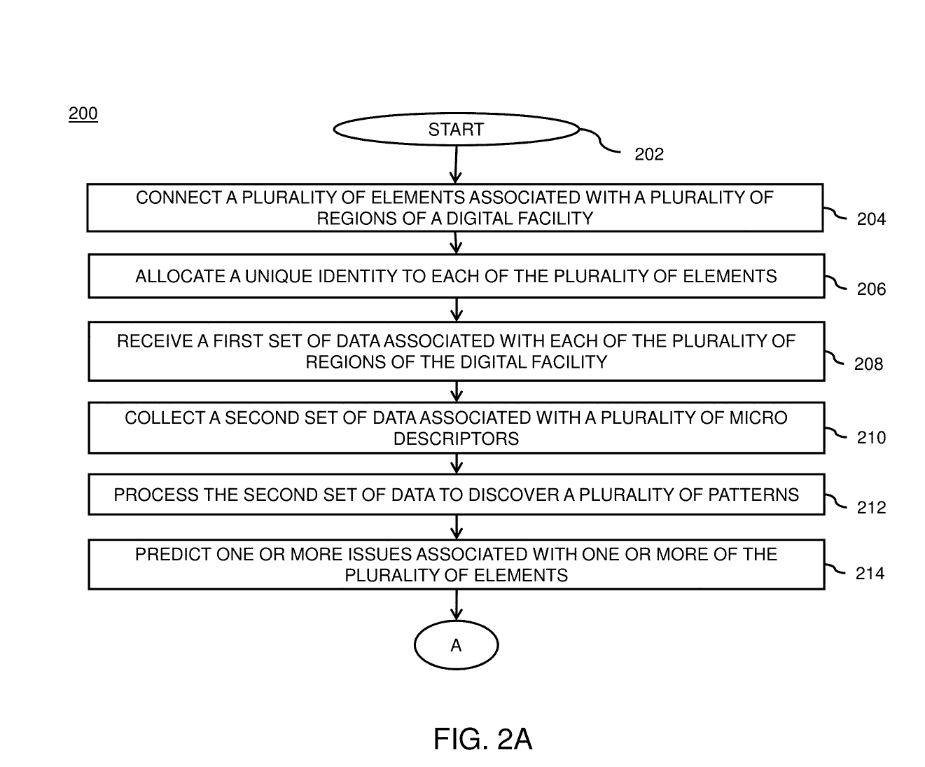

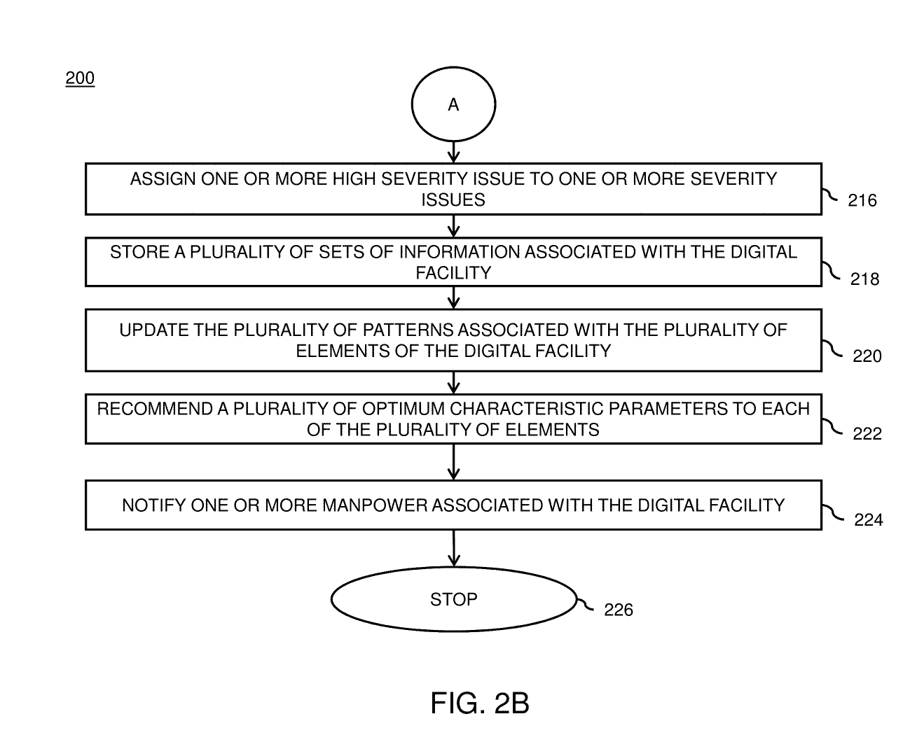

FIG. 2A and FIG. 2B illustrate a flowchart 200 for a method for quality control of the digital facility 102 based on the machine learning, in accordance with various embodiments of the present disclosure. It may be noted that to explain the process steps of the flowchart 200, references will be made to the system elements of FIG. 1A and FIG. 1B. It may be noted that the flowchart 200 may have lesser or more number of steps.

The flowchart 200 initiates at step 202. Following step 202, at step 204, the quality control system 110 connects the plurality of elements 106 associated with the plurality of regions 104 of the digital facility 102. At step 206, the quality control system 110 allocates the unique identity to each of the plurality of elements 106. At step 208, the quality control system 110 receives the first set of data associated with each of the plurality of regions 104 of the digital facility 102. The first set of data includes the plurality of architectural data. At step 210, the quality control system 110 collects the second set of data. The quality control system 110 collects the second set of data from the plurality of micro descriptors 108. The quality control system 110 collects the second set of data to ensure the quality control of the digital facility 102. At step 212, the quality control system 110 processes the second set of data to discover the plurality of patterns. Each of the plurality of patterns is associated with the characteristic attribute of the plurality of characteristic attributes of one or more of the plurality of elements 106. The quality control system 110 discovers the plurality of patterns with the facilitation of machine learning. At step 214, the quality control system 110 predicts the one or more issues associated with one or more of the plurality of elements 106 of the digital facility 102. The quality control system 110 predicts one or more issues with the facilitation of machine learning. The quality control system 110 predicts the one or more issues with the facilitation of the second set of data. At step 216, the quality control system 110 assigns the one or more high severity issue to the one or more issues. The one or more high severity issues correspond to the one or more issues with serious consequence on the performance of one or more of the plurality of elements 106. At step 218, the quality control system 110 stores the plurality of sets of information associated with the digital facility 102. The plurality of sets of information includes the first set of data, the second set of data, the plurality of patterns, one or more issues, the one or more high severity issues and the like. At step 220, the quality control system 110 updates the plurality of patterns associated with the plurality of elements 106 of the digital facility 102. The plurality of patterns is updated in the database of the quality control system 110. The plurality of patterns is updated based on the stored plurality of sets of information and machine learning. At step 222, the quality control system 110 recommends a plurality of optimum characteristic parameters to each of the plurality of elements 106. The plurality of optimum characteristic parameters is recommended to ensure quality of each of the plurality of elements 106. At step 224, the quality control system 110 notifies the one or more manpower associated with the digital facility 102. The quality control system 110 notifies the manpower about the one or more issues and the one or more high severity issues. The flow chart 200 terminates at step 226.

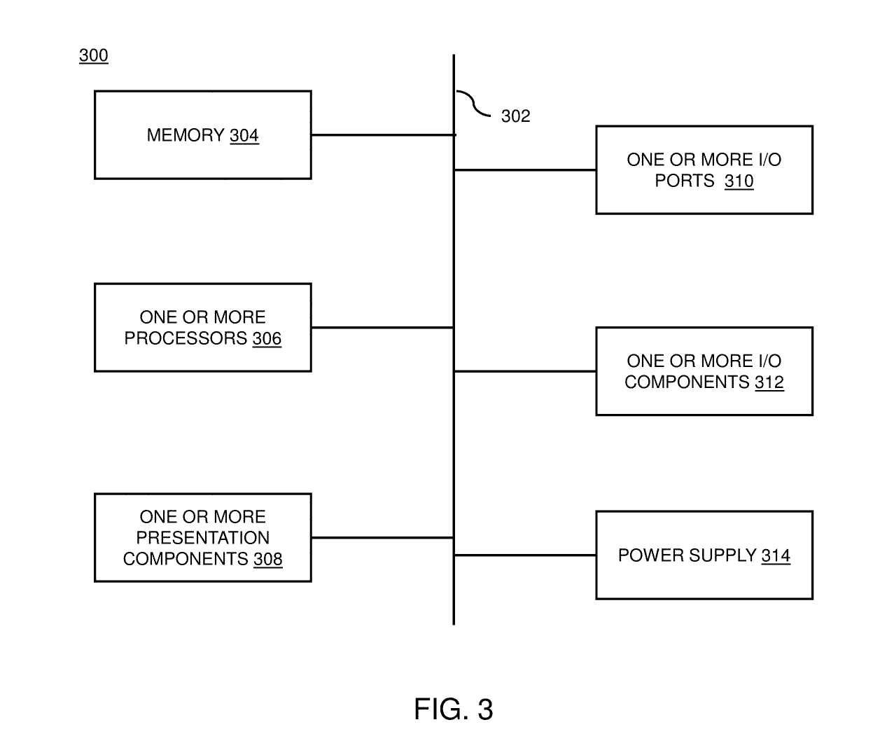

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312 and an illustrative power supply 314. The bus 302 represents what may be one or more busses (such as an address bus, data bus, or combination thereof). Although the various blocks of FIG. 3 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 3 is merely illustrative of an exemplary computing device 300 may be used in connection with one or more embodiments of the present disclosure. Distinction is not made between such categories as workstation, server, laptop, hand-held device and the like, as all are contemplated within the scope of FIG. 3 and reference to “the computing device 300.”

The computing device 300 typically includes a computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes but may not be limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer readable media.

Memory 304 includes the computer-storage media in the form of volatile and/or nonvolatile memory. The memory 304 may be removable, non-removable, or a combination thereof. Exemplary hardware devices include solid-state memory, hard drives, optical-disc drives and the like. The computing device 300 includes the one or more processors to read data from various entities such as memory 304 or I/O components 312. The one or more presentation components 308 present data indications to a user or other device. Exemplary presentation components include a display device, speaker, printing component, vibrating component and the like. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device and the like.

What is claimed is:

1. A computer-implemented method for quality control of a digital facility based on machine learning, the computer-implemented method comprising:
connecting, at a quality control system with a processor, a plurality of elements associated with a plurality of regions of the digital facility;
allocating, at the quality control system with the processor, a unique identity to each of the plurality of elements, wherein the unique identity being allocated based on a pre-defined pattern;
receiving, at the quality control system with the processor, a first set of data associated with each of the plurality of regions of the digital facility, wherein the first set of data comprises of a plurality of architectural data;
collecting, at the quality control system with the processor, a second set of data associated with a plurality of micro descriptors, wherein each of the plurality of micro descriptors being associated with one or more of the plurality of elements;
processing, at the quality control system with the processor, the second set of data to discover a plurality of patterns, wherein the processing being done based on attribute of the second set of data, wherein each of the plurality of patterns being associated with a characteristic attribute of the one or more of the plurality of elements;
predicting, at the quality control system with the processor, one or more issues associated with the one or more of the plurality of elements, wherein the prediction being enabled with the facilitation of the machine learning, wherein the prediction being done in real time;
assigning, at the quality control system with the processor, one or more high severity issues to the one or more severity issues, wherein the one or more high severity issues being assigned based on the second set of data and the machine learning;
storing, at the quality control system with the processor, a plurality of sets of information associated with the digital facility, wherein the plurality of sets of information being stored in a plurality of matrices, wherein the plurality of sets of information being stored in a database of the quality control system;
updating, at the quality control system with the processor, the plurality of patterns associated with the plurality of elements of the digital facility, wherein the plurality of patterns being updated in the database of the quality control system;
recommending, at the quality control system with the processor, a plurality of optimum characteristic parameters to each of the plurality of elements, wherein the plurality of optimum characteristic parameters being recommended to ensure quality of each of the plurality of elements; and
notifying, at the quality control system with the processor, one or more manpower associated with the digital facility.

2. The computer-implemented method as recited in claim 1, wherein the plurality of architectural sources comprises a facility manager, a digital camera, a digital blueprint, a communication device, one or more graphical sensors and a satellite image.

3. The computer-implemented method as recited in claim 1, wherein the plurality of elements comprises a plurality of electrical appliances, a plurality of furniture, a plurality of sanitary fittings, a plurality of structural fittings, a plurality of cutleries and a plurality of washroom fittings.

4. The computer-implemented method as recited in claim 1, wherein the one or more issues comprise fault in one or more of the plurality of electrical appliance, fault in one or more of the plurality of furniture, fault in one or more of the plurality of sanitary fittings, fault in one or more of the plurality of structural fittings, fault in one or more of the plurality of cutleries and fault in one or more of the plurality of washroom fittings.

5. The computer-implemented method as recited in claim 1, further comprising upgrading, at the quality control system with the processor, the first set of data, the second set of data, the one or more issues and the one or more high severity issue, wherein the updating being done in real time.

6. The computer-implemented method as recited in claim 1, further comprising preventing, at the quality control system with the processor, booking of one or more of the plurality of regions of the digital facility, wherein the prevention being done with the facilitation of the one or more high severity issues and the machine learning, wherein the prevention being done in real time.

7. The computer-implemented method as recited in claim 1, further comprising forecasting, at the quality control system with the processor, a time to resolve the one or more issues in order to maintain a quality of the digital facility, wherein the forecasting being done based on the machine learning.

8. The computer-implemented method as recited in claim 1, wherein the unique identity differentiates each of the plurality of elements of the digital facility, wherein the plurality of micro descriptors being coupled with the unique identity.

9. The computer-implemented method as recited in claim 1, wherein the plurality of micro descriptors provides data of a plurality of characteristic attributes of the plurality of elements.

10. A computer system comprising:
one or more processor; and
a memory coupled to the one or more processors, the memory for storing instructions which, when executed by the one or more processors, cause the one or more processors to perform a method for quality control of a digital facility based on machine learning, the method comprising:
connecting, at a quality control system, a plurality of elements associated with a plurality of regions of the digital facility;
allocating, at the quality control system, a unique identity to each of the plurality of elements, wherein the unique identity being allocated based on a pre-defined pattern;
receiving, at the quality control system, a first set of data associated with each of the plurality of regions of the digital facility, wherein the first set of data comprises of a plurality of architectural data;
collecting, at the quality control system, a second set of data associated with a plurality of micro descriptors, wherein each of the plurality of micro descriptors being associated with one or more of the plurality of elements;
processing, at the quality control system, the second set of data to discover a plurality of patterns, wherein the processing being done based on attribute of the second set of data, wherein each of the plurality of patterns being associated with a characteristic attribute of the one or more of the plurality of elements;
predicting, at the quality control system, one or more issues associated with the one or more of the plurality of elements, wherein the prediction being enabled with the facilitation of the machine learning, wherein the prediction being done in real time;
assigning, at the quality control system, one or more high severity issues to the one or more severity issues, wherein the one or more high severity issues being assigned based on the second set of data and the machine learning;
storing, at the quality control system, a plurality of sets of information associated with the digital facility, wherein the plurality of sets of information being stored in a plurality of matrices, wherein the plurality of sets of information being stored in a database of the quality control system;
updating, at the quality control system, the plurality of patterns associated with the plurality of elements of the digital facility, wherein the plurality of patterns being updated in the database of the quality control system;
recommending, at the quality control system, a plurality of optimum characteristic parameters to each of the plurality of elements, wherein the plurality of optimum characteristic parameters being recommended to ensure quality of each of the plurality of elements; and
notifying, at the quality control system, one or more manpower associated with the digital facility.

11. The computer system as recited in claim 10, wherein the plurality of architectural sources comprises a facility manager, a digital camera, a digital blueprint, a communication device, one or more graphical sensors and a satellite image.

12. The computer system as recited in claim 10, wherein the plurality of elements comprises a plurality of electrical appliances, a plurality of furniture, a plurality of sanitary fittings, a plurality of structural fittings, a plurality of cutleries and a plurality of washroom fittings.

13. The computer system as recited in claim 10, wherein the one or more issues comprise fault in one or more of the plurality of electrical appliance, fault in one or more of the plurality of furniture, fault in one or more of the plurality of sanitary fittings, fault in one or more of the plurality of structural fittings, fault in one or more of the plurality of cutleries and fault in one or more of the plurality of washroom fittings.

14. The computer system as recited in claim 10, further comprising upgrading, at the quality control system, the first set of data, the second set of data, the one or more issues and the one or more high severity issue, wherein the updating being done in real time.

15. The computer system as recited in claim 10, further comprising preventing, at the quality control system, booking of one or more of the plurality of regions of the digital facility, wherein the prevention being done with the facilitation of the one or more high severity issues and the machine learning, wherein the prevention being done in real time.

16. The computer system as recited in claim 10, further comprising forecasting, at the quality control system, a time to resolve the one or more issues in order to maintain quality of the digital facility, wherein the forecasting being done based on the machine learning.

17. The computer system as recited in claim 10, wherein the unique identity differentiates each of the plurality of elements of the digital facility, wherein the plurality of micro descriptors being coupled with the unique identity.

18. The computer system as recited in claim 10, wherein the plurality of micro descriptors provides data of a plurality of characteristic attributes of the plurality of elements.

19. A computer-readable storage medium encoding computer executable instructions that, when executed by at least one processor, performs a method for quality control of a digital facility based on machine learning, the method comprising:
connecting, at a computing device, a plurality of elements associated with a plurality of regions of the digital facility;
allocating, at the computing device, a unique identity to each of the plurality of elements, wherein the unique identity being allocated based on a pre-defined pattern;
receiving, at the computing device, a first set of data associated with each of the plurality of regions of the digital facility, wherein the first set of data comprises of a plurality of architectural data;
collecting, at the computing device, a second set of data associated with a plurality of micro descriptors, wherein each of the plurality of micro descriptors being associated with one or more of the plurality of elements;
processing, at the computing device, the second set of data to discover a plurality of patterns, wherein the processing being done based on attribute of the second set of data, wherein each of the plurality of patterns being associated with a characteristic attribute of the one or more of the plurality of elements;
predicting, at the computing device, one or more issues associated with the one or more of the plurality of elements, wherein the prediction being enabled with the facilitation of the machine learning, wherein the prediction being done in real time;
assigning, at the computing device, one or more high severity issues to the one or more severity issues, wherein the one or more high severity issue being assigned based on the second set of data and the machine learning;
storing, at the computing device, a plurality of sets of information associated with the digital facility, wherein the plurality of sets of information being stored in a plurality of matrices, wherein the plurality of sets of information being stored in a database of the quality control system;
updating, at the computing device, the plurality of patterns associated with the plurality of elements of the digital facility, wherein the plurality of patterns being updated in the database of the quality control system;
recommending, at the computing device, a plurality of optimum characteristic parameters to each of the plurality of elements, wherein the plurality of optimum characteristic parameters being recommended to ensure quality of each of the plurality of elements; and
notifying, at the computing device, one or more manpower associated with the digital facility.

20. The computer-readable storage medium as recited in claim 19, wherein the plurality of architectural sources comprises a facility manager, a digital camera, a digital blueprint, a communication device, one or more graphical sensors and a satellite image.
